(19) United States
(12) Patent Application Publication
(10) Pub. No.: US 2015/0046045 A1
(43) Pub. Date: Feb. 12, 2015

(54) SEEDING GROUP AND A METHOD OF ACTUATING A SEEDING GROUP

(71) Applicant: DELTA PROGETTI S.r.l., Berra (Ferrara) (IT)

(72) Inventors: Enrico Bighi, Berra (Ferrara) (IT); Roberto Pattaro, Berra (Ferrara) (IT)

(73) Assignee: DELTA PROGETTI S.r.I, Berra (Ferrara) (IT)

(21) Appl. No.: 14/384,114

(22) PCT Filed: Feb. 20, 2013
(86) PCT No.: PCT/IB2013/051378

§ 371 Date: Sep. 9, 2014

(30) Foreign Application Priority Data
Mar. 16, 2012 (IT) BO201A000139

(51) Int. Cl. A01C 7/16; A01C 21/00

(52) U.S. Cl. CPC A01C 7/16; A01C 21/005
USPC 701/50; 222/56

(57) ABSTRACT

A seeding group (11) comprises a distributor (1) for releasing seeds (2) to fall on a terrain (3). The group includes a rotary batching disc (5) provided with a plurality of seatings (6) for seeds (2), release of a seed (2) from a corresponding seating (6) occurring when the seating (6) runs through a predetermined circular sector. A control unit (13) receives a signal emitted by a first sensor (12) and commands rotation of the batching disc (5) for regulating release of the seeds (2) on the terrain (3). The first sensor (12) is a position sensor that detects a position of the seeding group (11) with respect to a reference point that is fixed in space.

### FIELD OF INVENTION

The present invention concerns the technical sector of seeding agricultural terrain; in particular the invention relates to a seeding group, which is part of a seeding machine, and to a method for actuating the seeding group.

### DESCRIPTION OF THE PRIOR ART

FIG. 1 schematically illustrates a first seeding group (10) of known type, which is a part of a seeding machine (not illustrated); the first seeding group (10) has the task of releasing seeds (2) onto an agricultural terrain (3) in such a way that the seeds (2) are arranged along one or more rows and at a predetermined reciprocal distance.

The first seeding group (10) comprises a distributor (1) for releasing seeds (2) to fall on the agricultural terrain (3), which distributor (1) in turn comprises: a hopper (4) containing the seeds (2); a rotary batching disc (5) provided with a plurality of seatings (6) for seeds, equidistanced angularly to one another, which batching disc (5) is supplied by the hopper (4); and aspirating means, not illustrated, such as to retain the seeds (2) in the respective seatings (6) of the batching disc (5). The aspirating action of the aspirating means is interrupted at a circular section: when a seating (6) transits at the circular sector the seed (2) contained therein is disengaged and falls onto the underlying agricultural terrain (3).

The first seeding group (10) further comprises an idle wheel (7) constrained to the frame (also not illustrated) of the seeding machine, which idle wheel (7) is maintained pressed on the agricultural terrain (3) so as to rotate when the seeding machine advances on the agricultural terrain (3); the wheel (7) is connected by a belt transmission (8) with the batching disc (5), so as to draw the disc (5) in rotation. When the seeding machine is moved, the wheel (7) rotates and draws the batching disc (5) in rotation, with a consequent regular release of seeds (2) onto the agricultural terrain (3); in order to regulate the seed (2) released in this way, a specific reduction is necessary between the wheel (7) and the batching disc (5).

An advantage of this first seeding group consists in the fact that an immediate and corresponding variation of drive of the batching disc corresponds to an acceleration/deceleration of the wheel.

The drawbacks are as follows.

The batching disc opposes a certain degree of inertia to rotation and this can lead to a skidding of the wheel drawing it, i.e. a temporary dragging of the wheel on the terrain such as to slow down or interrupt the release of the seeds from the batching disc: as a consequence, the seeds released onto the ground exhibit a greater and unforseen reciprocal distance. The probability of the wheel's skidding increases if, as often happens, the wheel draws a plurality of batching discs in rotation.

Further, the mechanical transmission leads to problems as follow: variation of the seeding distance (for each type of seed there exists an optimal distance between the seeds released onto the terrain); and the selective blocking of one or more batching discs during the advancing of the seeding machine so that one or more rows of the agricultural terrain are left out of seeding.

A second seeding group, not illustrated in the figures, is differentiated from the first seeding group due to the fact that the belt transmission between the wheel and the batching disc is not included.

Further, the second seeding group additionally comprises: an actuator which draws the batching disc in rotation; a sensor; and a control unit receiving the signals from the sensor and commands the actuator such as to daw the batching disc in rotation and thus regulate the release of the seeds onto the ground. The sensor is a velocity sensor which detects the advancing velocity of the seeding machine in which the second seeding group is integrated.

The second seeding group can also comprise a control panel which enables setting some parameters for the control unit; thus the seeding distance can be modified, or some rows can be left unseeded, and so on.

It is observed that the wheel does not exhibit skidding phenomena due to the fact that it no longer draws in rotation the batching disc. Consequently, the sensor can be connected to the wheel to detect the advancing velocity of the seeding machine.

Thus the drawbacks of the first seeding group are obviated. Additionally, a majority of the mechanical kinematisms is replaced by electric cabling with a consequent reduction of the weight of the second seeding group with respect to the first.

However, the second seeding group exhibits the drawback of being imprecise during the acceleration/deceleration steps of the seeding machine; in other words the batching disc cannot satisfactorily follow the variations in velocity of the seeding machine, which can lead to a wrong release of seeds onto the agricultural terrain (the predetermined seeding distances are not respected).

### SUMMARY OF THE INVENTION

The aim of the present invention consists in providing a seeding group which obviates the drawbacks typical of the prior art, as described above.

The aim is attained by means of a seeding group according to claim 1 and a method for actuating a seeding group according to claim 7.

It is possible to calculate, instant by instant, the theoretical angular position which the batching disc must assume according to the actual distance of the seeding group with respect to the reference point that is fixed in space; once this theoretical angular position is calculated, the batching disc can be commandedly rotated correspondingly.

The batching disc can advantageously be activated to follow, with an effective and precise dynamic, the accelerations/decelerations of the seeding group which can be deduced by detecting the position of the seeding group with respect to a reference point that is fixed in space.

In other words, the use of a position sensor instead of a velocity sensor, as in the prior art, has been shown to be crucial for reaching the predetermined aim.

### BRIEF DESCRIPTION OF THE DRAWINGS

Specific embodiments of the invention will be described in the following description, according to what is set out in the claims and with the aid of the accompanying tables of drawings, in which:

FIG. 1 schematically illustrates a first seeding group of known type;

FIG. 2 schematically and partially illustrates a seeding group according to the present invention;

FIG. 3 is a block diagram which illustrates the functional connection between some components that are a part of the seeding group of FIG. 2.

### DESCRIPTION OF THE PREFERRED EMBODIMENTS

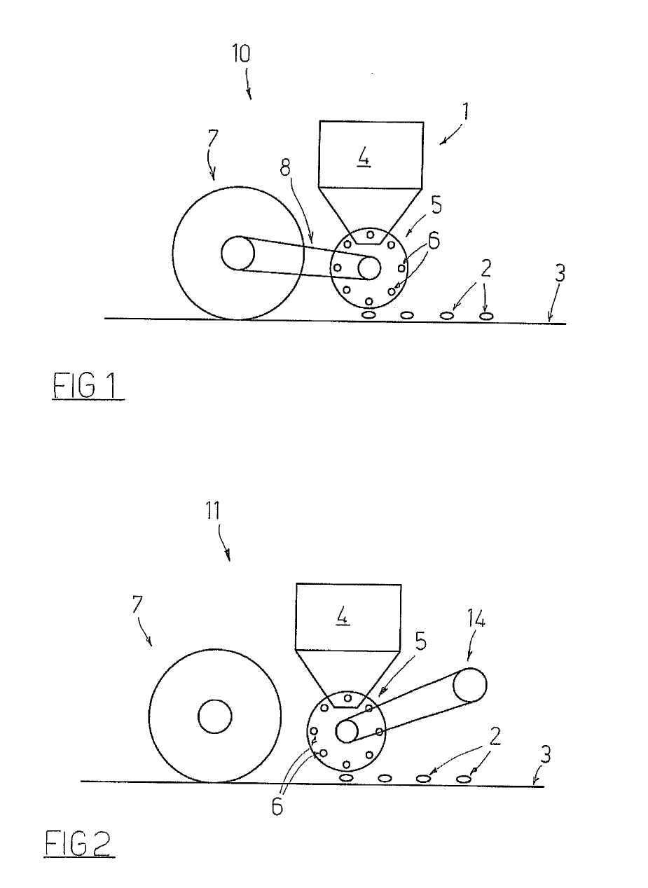

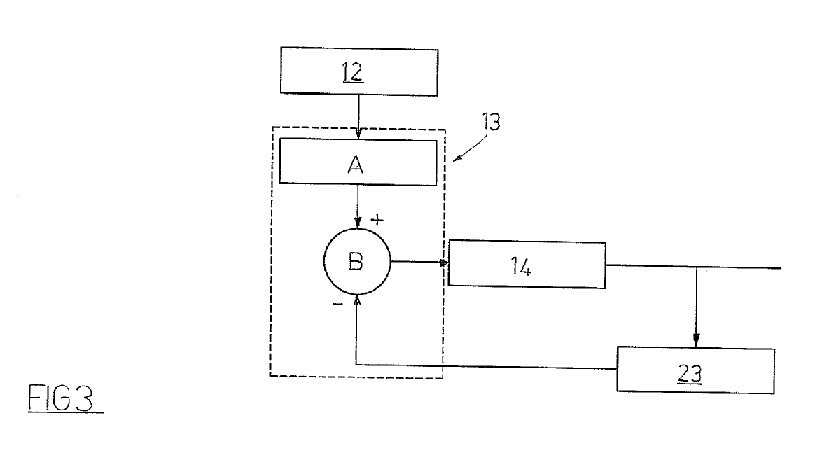

In the following, explicit reference with be made to FIGS. 2, 3; the characteristics of FIGS. 2, 3 that are identical to those of FIG. 1 will be denoted using the same numerical references.

The numeral (11) denotes in its entirety the seeding group that is the object of the present invention, which can be an integral part of a seeding machine (not illustrated). The seeding group (11) has the task of releasing seeds (2) onto an agricultural terrain (3) so that the seeds (2) become arranged along one or more rows and at a predetermined reciprocal distance.

The seeding group (11) comprises: a distributor (1) for releasing seeds (2) to fall onto a terrain (3), comprising a rotary batching disc (5) provided with a plurality of seatings (6) for seeds (2), release of a seed (2) from a corresponding seating (6) occurring when the seating (6) runs through a predetermined circular sector; a first sensor (12); a control unit (13) which receives the signal emitted by the first sensor (12) and commands rotation of the batching disc (5) for regulating release of the seeds (2) on the terrain (3).

The first sensor (12) is a position sensor that detects a position of the seeding group (11) with respect to a reference point that is fixed in space (not illustrated in the figures).

The seatings (6) of the batching disc (5) are preferably equidistanced angularly to one another.

The terrain is for example an agricultural terrain (3).

The distributor (1), in itself of known type, can comprise: a hopper (4) containing the seeds (2); and aspirating means, not illustrated, for retaining the seeds (2) in the respective seatings (6) of the batching discs (5). The batching disc (5) can be supplied by the hopper (4).The aspirating action of the aspirating means is interrupted at the circular sector: thus when a seating (6) transits at the circular sector the seed (2) contained therein is disengaged and falls onto the underlying agricultural terrain.

The batching disc (5) is for example vertically arranged; the above-cited circular sector can correspond in this case to the position in which the seating (6) is closer to the underlying agricultural terrain (3).

The seeding group (11) can further comprise an idle wheel (7) constrained to the frame (also not illustrated) of the seeding machine, which idle wheel (7) is maintained pressed on the agricultural terrain (3) such as to roll when the seeding machine advances on the agricultural terrain (3); the first sensor (12) (illustrated only schematically in FIG. 3) can be for example an encoder keyed on the wheel (7) or a phonic wheel keyed on the wheel (7).

Alternatively, the first position sensor (12) can be a GPS.

When the seeding machine is stationary, the reference point fixed in space can correspond for example to the position assumed by the seeding machine itself, to which position the position detected by the encoder or the phonic wheel or the GPS is associable.

The seeding group (11) can comprise a second sensor (23) (illustrated only schematically in FIG. 3) that is a position sensor for detecting an angular position of the batching disc (5); in this case the control unit (13) receives a signal emitted by the second sensor (23).

The seeding group (11) can comprise an actuator (14), for example an electric motor, which draws the batching disc (5) in rotation; the control unit (13) acts, in this case, directly on the actuator (14) such as to control the release of seeds (2) by the batching disc (5).

The control unit (13) can implement a feedback system in which an amount proportional to the signal received from the first sensor (12) is compared with an amount proportional to the signal received from the second sensor (23) with the aim of controlling the angular position assumed by the batching disc (5).

In detail, see FIG. 3, the signal in output from the first sensor (12) can be sent to a first block (A) of the control unit (13); the block (A) emits in output a signal that is proportional to the reduction ratio desired. The reduction ration can be varied by the user, for example via a control panel not illustrated in the figures: in this way it is for example possible to set the distance that the seeds (2) released on the agricultural terrain (3) must have with respect to one another.

The control unit (13) further comprises a second block (B) for comparison which receives in input the output signal from the first block (A) and the signal coming from the second sensor (23), possibly amplified; the second block (B) for comparison carries out a difference between the signal in output from the first block (A) and the signal proportional to the signal in output from the second sensor (23); the outcome of this difference serves to pilot the actuator (14), with a proportionality factor.

A method is also defined for activating a seeding group, comprising following steps: activating a rotary batching disc (5) provided with a plurality of seatings (6) for seeds (2), release of a seed (2) from the corresponding seating (6) occurring when the seating (6) displaces through a predetermined circular sector; detecting a position of the seeding group with respect to a reference point that is fixed in space; commanding rotation of the batching disc (5) on the basis of the detection, in order to regulate the release of seeds (2) on the terrain (3).

Additionally, the method can comprise following steps: detecting the angular position of the batching disc (5); performing a comparison between the detected position of the seeding group and the detected angular position of the batching disc (5) and consequently commanding the rotation of the batching disc (5) such as to regulate the release of seeds (2) onto the terrain (3).

The foregoing has been described by way of non-limiting example, and any constructional variations are understood to fall within the protective scope of the present technical solution, as claimed in the following.

Amendments to the claims:

1. A seeding group, comprising:
a distributor for releasing seeds to fall on a terrain, comprising a rotary batching disc provided with a plurality of seatings for seeds, release of a seed from a corresponding seating occurring when the seating runs through a predetermined circular sector;
a first sensor;
a control unit which receives the signal emitted by the first sensor and commands rotation of the batching disc for regulating release of the seeds on the terrain;
wherein:
the first sensor is a position sensor that detects a position of the seeding group with respect to a reference point that is fixed in space.

2. The group of claim 1, comprising a second sensor that is a position sensor for detecting an angular position of the batching disc, and wherein the control unit receives a signal emitted by the second sensor.

3. The group of claim 2, wherein the control unit implements a feedback system in which an amount proportional to the signal received from the first sensor is compared with an amount proportional to the signal received from the second sensor with the aim of controlling the angular position assumed by the batching disc.

4. The group of claim 1, comprising a wheel for rolling on the terrain, wherein the first position sensor is an encoder keyed on the wheel or a phonic wheel keyed on the wheel or a GPS detector.

5. The group of claim 2, wherein the second sensor is an encoder keyed on the shaft that draws the batching disc or a phonic wheel keyed on the shaft which draws the batching disc.

6. A seeding machine, comprising the seeding group according to claim 1.

7. A method for activating a seeding group, comprising: activating a rotary batching disc provided with a plurality of seatings for seeds, release of a seed from the corresponding seating occurring when the seating displaces through a predetermined circular sector;
detecting a position of the seeding group with respect to a reference point that is fixed in space;
commanding rotation of the batching disc on the basis of the detection, in order to regulate the release of seeds on the terrain.

8. The method of claim 7, further comprising: detecting the angular position of the batching disc; performing a comparison between the detected position of the seeding group and the detected angular position of the batching disc and consequently commanding the rotation of the batching disc such as to regulate the release of seeds onto the terrain.

9. The group of claim 2, comprising a wheel for rolling on the terrain, wherein the first position sensor is an encoder keyed on the wheel or a phonic wheel keyed on the wheel or a GPS detector.

10. The group of claim 9, wherein the second sensor is an encoder keyed on the shaft that draws the batching disc or a phonic wheel keyed on the shaft which draws the batching disc.
